(19) United States
(12) Patent Application Publication
(10) Pub. No.: US 2006/0211379 A1
(43) Pub. Date: Sep. 21, 2006

(54) System and method for selecting and reselecting antenna direction at a transceiver

(76) Inventors: Ramesh Mantha, Toronto (CA); Anthony Gerkis, Richmond Hill (CA); Ben Gamsa, Toronto (CA)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 10/548,839

(22) PCT Filed: Mar. 9, 2004
(86) PCT No.: PCT/CA04/00346

§ 371 Date: Apr. 6, 2006

(30) Foreign Application Priority Data
Mar. 10, 2003 (CA) 2421578

(51) Int. Cl. H04B 1/38

(52) U.S. Cl. 455/73

(57) ABSTRACT

A method and system for selecting and reselecting an antenna direction for an antenna capable of transmitting signals in one of at least two selectable directions. The average received signal-to-interference ratio is used to initially select the antenna direction. Thereafter the average received signal-to-interference ratio is monitored and the antenna direction reselected when the average received signal-to-interference ratio rises too far below the average received signal-to-interference ratio used to initially select the antenna direction for too long too often and if the antenna is not then required for a transmission that cannot be interrupted. If the average received signal-to-interference ratio drops significantly below the level used to initially select the antenna direction, then that level is reset downward. Reselection, if commenced, is repeated periodically until the antenna is required for transmission of a signal.

### FIELD OF THE INVENTION

The present invention relates to a system and method for mitigating poor communication between radio transceivers in a wireless network. More specifically, the present invention relates to a system and method to mitigate poor reception and transmission by selecting and reselecting an antenna direction at a transceiver.

### BACKGROUND OF THE INVENTION

It has been suggested in U.S. patent application Ser. Nos. 09/775,510 and 09/899,927, published Jan. 16, 2003 and Nov. 21, 2002, respectively, both of which are assigned to the applicant, that an antenna that receives or transmits preferentially in a selectable direction may be advantageously used in a subscriber station of a wireless local loop system. Those applications suggest that the antenna direction should be selected at start-up and reselected from time to time based upon a metric that measures the quality of the radio frequency link between a base station and the subscriber station of the local loop system. They also suggest a number of criteria for choosing times to reselect antenna direction.

In co-pending Canadian Patent Application 2,361,186, filed Nov. 2, 2001, the applicant has provided a method for rapidly reselecting antenna direction that is designed to deal with rapidly changing link quality. While that method disclosed provides advantages over methods that require special modes of operation, such as compressed mode in 3GPP, it can result in a reduction of the data rate because changes in antenna direction can take place while data is being communicated. Doing so may cause increased errors if a new antenna direction provides a poor link. Further, Canadian Patent Application 2,361,186 is not specifically directed to dealing with relatively slow changes in the macroscopic propagation environment.

A method and system is needed for ensuring that relatively slow changes in the macroscopic propagation environment (e.g., changes in the physical location of objects in the propagation environment, re-orientation or re-location of the subscriber station's antenna, etc.) do not degrade the link quality once an antenna direction has been selected. Such a method and system should preferably not require special modes of operation, should be simple and straight-forward to implement using existing request and connection states, be service-context sensitive, and ensure that reselection of antenna direction does not result in a data service interruption or an inability to meet a guaranteed bandwidth request.

### SUMMARY OF THE INVENTION

The inventors believe that it is advantageous for a subscriber station to include an antenna mechanism having a selectable preferred direction of reception or transmission or both and to select that direction such that the signal received by the subscriber station from a base station is of the highest quality. The metric that they presently consider best for measuring signal quality is an average signal-to-interference ratio for signals received by the subscriber station from the base station, although other suitable metrics may also be used and the use of such other metrics is within the scope of the invention.

According to one aspect of the present invention a method is provided for selecting and reselecting an antenna direction for an antenna capable of receiving signals preferentially from or transmitting signals in one of at least two selectable directions. The method includes determining the value of a suitable metric, such as average received signal-to-interference ratio, for each of the selectable antenna directions, selecting the antenna direction to be an antenna direction having a best value of the metric, and then monitoring the value of the metric for the selected antenna direction and reselecting the antenna direction when the value of the metric for the selected antenna direction falls below a minimum value.

Preferably, the antenna direction is reselected whenever the value of the metric for the selected antenna direction drops below the value of the metric last used to select the antenna direction by a lower hysteresis margin for a first time-to-trigger period and that condition has not occurred more than once during a pending-time-after-trigger period.

Preferably, once begun, reselection of the antenna direction continues periodically until the antenna is required for a dedicated channel.

Preferably, whenever the value of the metric for the selected antenna direction raises above the value of the metric last used to select the antenna direction by an upper hysteresis margin for a second time-to-trigger period, the value of the metric last used to select the antenna direction is set to the value of the metric for the selected antenna direction.

Preferably, the antenna direction is not reselected if the antenna is in use for a dedicated channel that has been guaranteed bandwidth or for some other process cannot continue if the antenna direction changed.

If separate antennas for reception and transmission of signals are available, the method for selecting and reselecting an antenna direction according to the present invention may be applied separately to each antenna so that each antenna direction is selected and reselected independently of the other antenna direction.

According to another aspect of the present invention a transceiver is provided that includes an antenna mechanism capable of receiving signals preferentially from or transmitting signals in one of at least two selectable directions, a controller connected to the antenna mechanism for setting a direction at which the antenna mechanism transmits signals, a processor connected to the controller for determining the direction at which to instruct the controller to set direction at which the antenna mechanism transmits signals, and a radio connected to the antenna mechanism and the processor for receiving signals from the antenna mechanism and providing measurements of received signal quality to the processor. At startup the processor is configured to instruct the controller to set direction at which the antenna mechanism receives or transmits signals to each of the selectable antenna directions in turn and determine a value of a suitable metric for each selectable antenna direction from measurements of received signal quality provided by the radio. The processor then selects a best antenna direction based upon the determined values of the metrics and instructs the controller to set the antenna direction to that best direction. The processor then monitors the value of the metric for the selected antenna direction and reselects the antenna direction when the value of the metric for the selected antenna direction falls below a minimum value. Preferably the metric is average received signal-to-interference ratio. The manner in which the processor monitors the value of the metric for the selected antenna direction and reselects the antenna direction when the value of the metric for the selected antenna direction falls below a minimum value is described above in relation to the first aspect of the present invention.

A transceiver according to the present invention may include separate antennas for reception and transmission of signals, in which case each antenna direction may be selected and reselected independently of the other antenna direction.

### BRIEF DESCRIPTION OF THE DRAWINGS

Preferred embodiments of the present invention will now be described, by way of example only, with reference to the attached Figures, wherein:

FIG. 1 is a schematic view of communications system in accordance with an embodiment of the present invention;

FIG. 2 is a schematic view of subscriber station transceiver in accordance with an embodiment of the present invention; and

FIGS. 3-7 are flowcharts illustrating a process of selecting and reselecting the setting of the direction of the antenna mechanism of the transceiver of FIG. 2.

### DETAILED DESCRIPTION OF THEE INVENTION

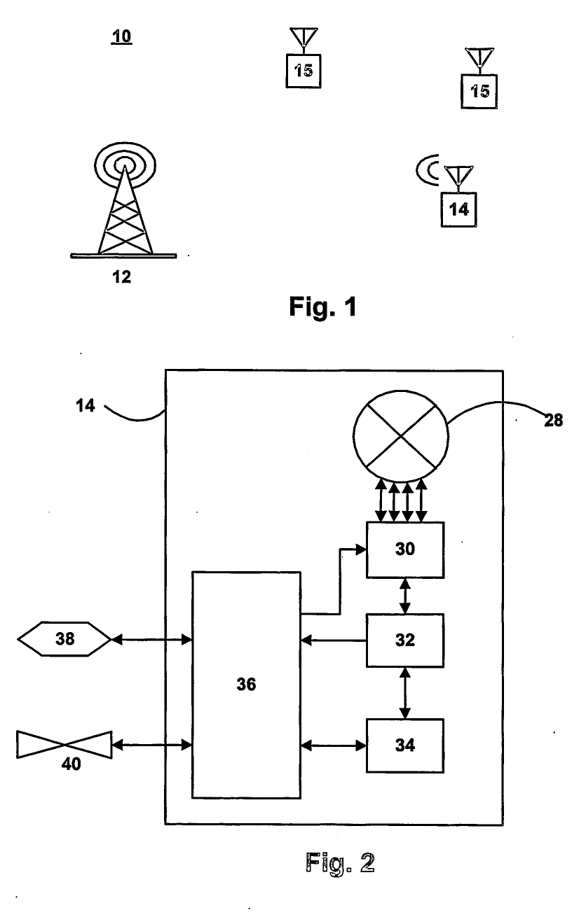

FIG. 1 shows a subscriber station 14 for communicating by radio signals with a base station 12 as part of a wireless communications system 10 in accordance with an embodiment of the present invention. It is assumed that the subscriber station 14 receives data from the base station 12 over a broadcast channel in common with a plurality of other transceivers 15 (only two of which are shown in FIG. 1) in the communications system 10. Further, the subscriber station 14 may communicate bi-directionally with the base station 12 over a dedicated channel and may when necessary send messages to the base station 12 over a random access channel that it shares with other transceivers 15 in the communications system 10. The dedicated channel may be used for services that require a guaranteed bandwidth, such as voice-over-IP, as well as data services that can operate successfully without a guaranteed bandwidth or latency. Those readers skilled in art will understand that certain features to be described are not necessary in systems that do not have the features just described, such as dedicated channels that may guarantee bandwidth, random access channels, and common broadcast channels. However, such readers will understand how the invention may be applied in such other systems.

The subscriber station 14 is capable of receiving signals transmitted by the base station 12 and transmitting signals to the base station 12 preferentially in one of at least two selectable directions. The subscriber station 14 would typically be located inside a room (not shown) of a building (not shown), but not necessarily in front of a window that would provide line-of-sight communication with the base station 12. Those skilled in the art will understand that signals transmitted by the base station 12 will in general bounce off one or more buildings or other objects before entering the room in which the subscriber station 14 is located through a window or by penetrating a wall. Further, signals may bounce off walls of the room. A signal transmitted by the base station 12 will in general arrive at the subscriber station 14 from all directions with a signal strength and phase that varies with direction, resulting in a local RF environment that may have closely spaced nulls and peaks due to interference between different signal paths. Furthermore, the signal at the subscriber station 14 may change drastically if the macroscopic environment surrounding the subscriber station 14 changes due to movement of the subscriber station 14, objects and people in the room, and objects outside the room. Similarly, such changes will affect signals transmitted by the subscriber station 14 and received by the base station 12.

While an omni-directional antenna could be used in the subscriber station 14, the inventors have found that if the subscriber station 14 uses a directional antenna whose orientation is selected on-start up and may be reselected when the reception quality at the subscriber station 14 changes, then the throughput of data between the subscriber station 14 and the base station 12 will generally be better than if subscriber station 14 uses an omni-directional antenna.

More specifically, the inventors have found that it is generally advantageous to select the direction at which the subscriber station 14 both receives from and transmits signals to the base station 12 to be that direction in which the signal received by the subscriber station 14 from the base station 12 is of the highest quality, which may not necessarily be the direction at which the radio frequency radiation field at the subscriber station 14 is the strongest. The metric that they presently consider best for measuring signal quality is an average signal-to-interference ratio (“SIR”), although other suitable metrics may also be used and the use of such other metrics is within the scope of the invention. They have also found that it is important to use an average measurement of the SIR as the signal may be subject to fast fading.

A suitable antenna mechanism for use in an embodiment of the invention can, for example, be similar to that described in U.S. patent application Ser. No. 09/775,510. Another example of a suitable antenna mechanism 16 can be similar to that described in U.S. patent application Ser. No. 09/899,927. Both of the antennas described in those applications allow for selection between antenna configurations so that a preferred direction for reception or transmission or both can be selected. Other examples of a suitable antenna mechanism, such as multiple directional antennas, will occur to those of skill in the art. In fact, any antenna mechanism that has a selectable preferred reception and transmission direction could be used.

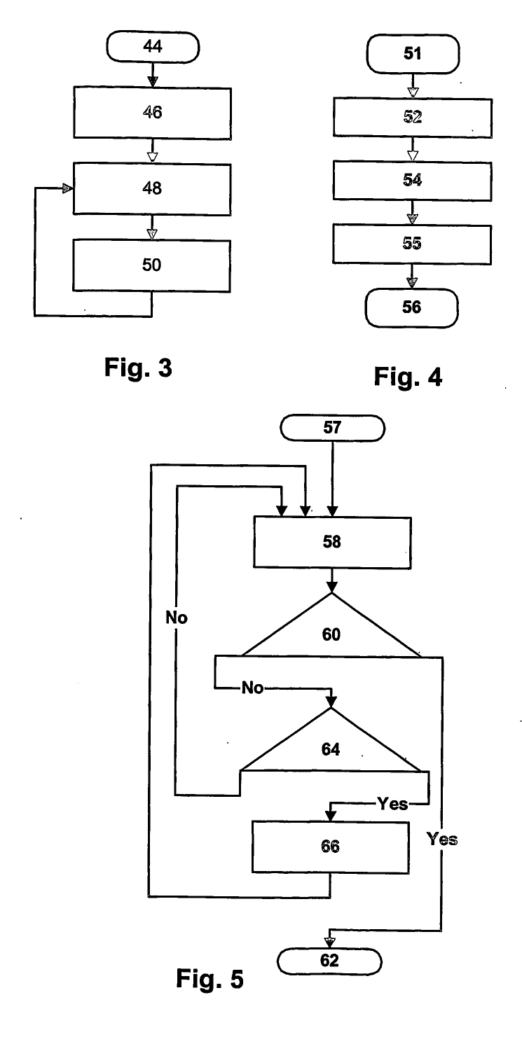

As shown in more detail in FIG. 2, the subscriber station 14 includes a directional antenna 28 whose preferred direction of reception and transmission can be changed in response to changes in the macroscopic environment. The subscriber station 14 also includes a controller 30 to select between the available antenna directions, a radio 32 and a modem 34. The radio 32 and a modem 34 receive signals from the antenna 28 and convert the signals into data. A processor 36, such as an Intel StrongArm processor, processes the received data and provides it to data devices 38 or telephony devices 40, which are connected to the subscriber station 14. The radio 32 includes a reception quality evaluation function that measures the value of the signal-to-interference ratio, and provides measurements of that value to the processor 36. The processor 36 is operable to respond to these measurements to determine average signal-to-interference ratios, select antenna directions, and instruct controller 30 to set and reset an antenna direction for the antenna 28.

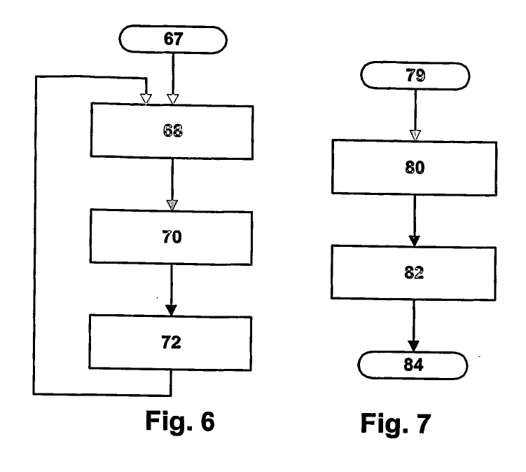

An antenna-control process, shown generally in FIG. 3, is employed by the processor 38 to select and reselect antenna direction. The process shown in FIG. 3 starts at block 44 and runs three other processes: an initial-selection process; a reception-quality monitoring process; and a reselection process, which are discussed below and shown in more detail in FIGS. 4, 5 and 6, respectively. FIG. 7 shows a fragment of a process that interacts with the antenna-control process when it requires use of the antenna 28 to transmit a message on a random access channel.

As illustrated in FIG. 3, the antenna-control process is comprised of, at block 46, running the initial-selection process shown in FIG. 4 to make an initial selection of an antenna direction when the subscriber station 14 initiates communication with the base station 12 and then repeating a loop comprising blocks 48 and 50 so long as the subscriber station 14 maintains communication with the base station 12.

The initial selection process, shown in FIG. 4, begins at block 51 and proceeds to determine at block 52 the value of the average signal-to-interference ratio for each of the selectable antenna directions. Then, at block 54, a direction setting for the antenna 28 is selected as the direction having the highest average signal-to-interference ratio and at block 55 the controller is instructed to set the antenna direction to that direction. The initial selection process then terminates at block 56.

The antenna-control process runs the reception-quality monitoring process shown in FIG. 5 runs until the earlier of:

(1) the average signal-to-interference ratio becomes unsatisfactory (as defined in detail below) and use of the antenna 28 is not required by some other process that has been guaranteed bandwidth, or

(2) some other process determines that the antenna direction should be reselected.

If either of those events occurs, then at block 50 the reselection process runs until the antenna 28 is required to provide a dedicated data channel, subject to momentary interruption to handle transmission of messages on a random access channel. In any case, the reselection process runs long enough to reset the antenna direction at least once before control is returned to the reception-quality monitoring process.

The reception-quality monitoring process, shown in FIG. 5, decides when an antenna direction reselection should occur by monitoring the average signal-to-interference ratio for the antenna direction to which the antenna 28 is presently set. The decision depends upon several predetermined quantities that may be adjusted depending upon experience. Those quantities are a last pending-time-after-trigger period, a first time-to-trigger period, a second time-to-trigger period, a lower hysteresis margin, and a upper hysteresis margin.

The reception-quality monitoring process starts at block 57 and proceeds to block 58 at which the average signal-to-interference ratio for the antenna direction to which the antenna 28 is presently set is redetermined. After redetermining the average signal-to-interference ratio a check is made at block 60 to determine if the average signal-to-interference ratio during the last pending-time-after-trigger period has been:
(1) less than the average signal-to-interference ratio measured when the antenna direction was last set or reset;
(2) by the lower hysteresis margin; and
(3) longer than the first time-to-trigger period,
   and there is no dedicated channel being provided by the subscriber station 14 that has been guaranteed bandwidth then the reception-quality monitoring process terminates at block 62. If not, then a further check is made at block 64 to determine if the average signal-to-interference ratio has been:
(1) above the average signal-to-interference ratio measured when the antenna direction was last set or reset;
(2) by the upper hysteresis margin; and
(3) for longer than a second time-to-trigger period.
   If it has, then at block 66 the average signal-to-interference ratio measured when the antenna direction was last set or reset is set equal to the present average signal-to-interference ratio and the process loops back to block 58 and continues as above. Otherwise, the process loops back to block 58 without changing the average signal-to-interference ratio measured when the antenna direction was last set or reset is reset. As will be clear from the discussion above, the reception-quality monitoring process will continue until the average signal-to-interference ratio becomes unsatisfactory and there is no dedicated channel that has been guaranteed bandwidth, in which case the process will terminate at block 62. In addition, as discussed above, the overall process shown in FIG. 3 may terminate the reception-quality monitoring process if some other process requires immediate antenna direction reselection.

The reselection process, shown in FIG. 6, starts at block 67 and runs a loop that begins in block 68 by re-determining the average signal-to-interference ratio for each of the selectable antenna directions. Then at block 70 a direction setting for the antenna 28 is selected to be the antenna direction having the highest average signal-to-interference ratio and the controller 32 is instructed to set the antenna direction accordingly. Then at block 72 the reselection process delays before continuing with the loop at block 68. The delay is optional.

FIG. 7 shows a portion of another process that starts at block 79 and may run on the subscriber station 14 concurrently with the reselection process and that may require that the antenna 28 be used to transmit a message to the base station on a random access channel. If that happens at the same time that the reselection process is running, the reselection process is interrupted so that the antenna 28 may be used to send the message and then restarted. This is illustrated by block 80, which represents zero or more steps in the process, block 82, which represents the steps of interrupting the reselection process, sending the message, and restarting the reselection process, and block 84, which represents the remaining steps in the process.

Those skilled in the art will understand that the order in which certain steps in the processes described above take place can be interchanged or combined with other steps without affecting the result. For example, in FIG. 5, blocks 64 and 66 could be run before block 60. Changing the order of blocks 64/66 and block 60 may under some conditions affect how often the reception quality monitoring process re-determines the average signal-to-interference ratio.

Those skilled in the art will also understand that a transceiver 14 may include separate receiving and transmitting antennas (not shown). In that case, the method described above may be applied separately for each antenna, so that the antenna direction for each antenna is selected and reselected based upon the reception quality at the respective antenna. The inventors have found that the reception quality generally varies so much over short distances that each antenna direction is best set independently of the other antenna direction. It is conceivable that under some conditions this might not be the case, in which case a third antenna might be used to monitor reception quality in all directions and its data be used to select and reselect the antenna directions of the receiving and transmitting antennas. Depending upon the nature of the data being received or transmitted, the antenna directions of the receiving and transmitting antennas might then be changed asynchronously.

The above-described embodiment of the invention is intended to be an example of the present invention. Alterations and modifications may be effected thereto by those of skill in the art, without departing from the scope of the invention, which is defined solely by the claims appended hereto.

1. A method for selecting and reselecting an antenna direction for a first antenna capable of transmitting signals preferentially in one of at least two selectable directions to a second antenna, comprising:
(i) determining the value of a suitable metric for each of the selectable antenna directions;
(ii) selecting the antenna direction to be an antenna direction having a best value of the metric; and then
(iii) monitoring the value of the metric for the selected antenna direction and reselecting the antenna direction by following steps (i) and (ii) above whenever the value of the metric for the selected antenna direction falls below a minimum value.

2. The method of claim 1, wherein the antenna direction is reselected whenever the value of the metric for the selected antenna direction drops below the value of the metric last used to select the antenna direction by a lower hysteresis margin for a first time-to-trigger period.

3. The method of claim 1, wherein the antenna direction is reselected whenever:
(a) the value of the metric for the selected antenna direction drops below the value of the metric last used to select the antenna direction by a lower hysteresis margin for a first time-to-trigger period and
(b) condition (a) has not occurred more than once during a pending-time-after-trigger period.

4. The method of any one of claim 1, wherein after each reselection of the antenna direction, steps (i) and (ii) are repeated until the first antenna is required for providing a dedicated channel.

5. The method of any of claim 1, wherein whenever the value of the metric for the selected antenna direction raises above the value of the metric last used to select the antenna direction by an upper hysteresis margin for a second time-to-trigger period, the value of the metric last used to select the antenna direction is set to the value of the metric for the selected antenna direction.

6. The method of any one of claim 1, wherein reselection of the antenna direction may be interrupted to transmit a signal on a random access channel.

7. The method of any one of claim 1, wherein the antenna direction is not reselected while the first antenna is in use for providing a channel subject to a guaranteed bandwidth constraint.

8. The method of any one of claim 1, wherein the metric is a function of an average received signal-to-interference ratio for signals received by the first antenna that were transmitted by a second antenna.

9. A method for selecting and reselecting an antenna direction for a first antenna capable of receiving signals transmitted by a second antenna preferentially from one of at least two selectable directions, comprising:
(i) determining the value of a suitable metric for each of the selectable antenna directions;
(ii) selecting the antenna direction to be an antenna direction having a best value of the metric; and then
(iii) monitoring the value of the metric for the selected antenna direction and reselecting the antenna direction by following steps (i) and (ii) above whenever the value of the metric for the selected antenna direction falls below a minimum value.

10. The method of claim 9, wherein the antenna direction is reselected whenever the value of the metric for the selected antenna direction drops below the value of the metric last used to select the antenna direction by a lower hysteresis margin for a first time-to-trigger period.

11. The method of claim 9, wherein the antenna direction is reselected whenever:
(a) the value of the metric for the selected antenna direction drops below the value of the metric last used to select the antenna direction by a lower hysteresis margin for a first time-to-trigger period and
(b) condition (a) has not occurred more than once during a pending-time-after-trigger period.

12. The method of any of claim 9, wherein after each reselection of the antenna direction, steps (i) and (ii) are repeated until the first antenna is required for proving a dedicated channel.

13. The method of any of claim 9, wherein whenever the value of the metric for the selected antenna direction raises above the value of the metric last used to select the antenna direction by an upper hysteresis margin for a second time-to-trigger period, the value of the metric last used to select the antenna direction is set to the value of the metric for the selected antenna direction.

14. The method of any one of claim 9, wherein reselection of the antenna direction may be interrupted to transmit a signal on a random access channel.

15. The method of any one of claim 9, wherein the antenna direction is not reselected while the first antenna is in use for providing a channel subject to a guaranteed bandwidth constraint.

16. The method of any one of claim 9, wherein the metric is a function of an average received signal-to-interference ratio for signals received by the first antenna that were transmitted by a second antenna.

17. A transceiver, comprising:
a first antenna capable of transmitting signals preferentially in one of at least two selectable directions to a second antenna;
a controller for setting a direction at which the first antenna transmits signals;
a processor for determining the direction at which to instruct the controller to set direction at which the first antenna transmits signals; and
a radio for receiving signals from the first antenna and providing measurements of received signal quality to the processor,
wherein the processor instructs the controller to set direction at which the first antenna transmits signals to each of the selectable antenna directions in turn and determines a value of a suitable metric for each selectable antenna direction from measurements of received signal quality provided by the radio, selects a best antenna direction based upon the determined metrics, instructs the controller to set the antenna direction to that best direction, and then monitors the value of the metric for the selected antenna direction and reselects the antenna direction whenever the value of the metric for the selected antenna direction falls below a minimum value.

18. The transceiver of claim 17, wherein the antenna direction is reselected whenever the value of the metric for the selected antenna direction drops below the value of the metric last used to select the antenna direction by a lower hysteresis margin for a first time-to-trigger period.

19. The transceiver of claim 17, wherein the antenna direction is reselected whenever:
(a) the value of the metric for the selected antenna direction drops below the value of the metric last used to select the antenna direction by a lower hysteresis margin for a first time-to-trigger period and
(b) condition (a) has not occurred more than once during a pending-time-after-trigger period.

20. The transceiver of any of claim 17, wherein after each reselection of the antenna direction, reselection is repeated until the first antenna is required for providing a dedicated channel.

21. The transceiver of any of claim 17, wherein whenever the value of the metric for the selected antenna direction raises above the value of the metric last used to select the antenna direction by an upper hysteresis margin for a second time-to-trigger period, the value of the metric last used to select the antenna direction is set to the value of the metric for the selected antenna direction.

22. The method of any one of claim 17, wherein reselection of the antenna direction may be interrupted to transmit a signal on a random access channel.

23. The transceiver of any one of claim 17, wherein the antenna direction is not reselected while the first antenna is in use for providing a channel subject to a guaranteed bandwidth constraint.

24. The transceiver of any one of claim 17, wherein the metric is a function of an average received signal-to-interference ratio for signals received by the first antenna that were transmitted by a second antenna.

25. A transceiver, comprising:
a first antenna capable of receiving signals preferentially from one of at least two selectable directions;
a controller for setting a direction from which the first antenna preferentially receives signals;
a processor for determining the direction at which to instruct the controller to set direction from which the first antenna preferentially receives signals; and
a radio for receiving signals from the first antenna and providing measurement s of received signal quality to the processor,
wherein the processor instructs the controller to set direction from which the first antenna receives signals to each of the selectable antenna directions in turn and determines a value of a suitable metric for each selectable antenna direction from measurements of received signal quality provided by the radio, selects a best antenna direction based upon the determined metrics, instructs the controller to set the antenna direction to that best direction, and then monitors the value of the metric for the selected antenna direction and reselects the antenna direction whenever the value of the metric of the selected antenna direction falls below a minimum value.

26. The transceiver of claim 25, wherein the antenna direction is reselected whenever the value of the metric for the selected antenna direction drops below the value of the metric last used to select the antenna direction by a lower hysteresis margin for a first time-to-trigger period.

27. The transceiver of claim 25, wherein the antenna direction is reselected whenever:
(a) the value of the metric for the selected antenna direction drops below the value of the metric last used to select the antenna direction by a lower hysteresis margin for a first time-to-trigger period and
(b) condition (a) has not occurred more than once during a pending-time-after-trigger period.

28. The transceiver of any of claim 25, wherein after each reselection of the antenna direction, reselection is repeated until the first antenna is required for providing a dedicated channel.

29. The transceiver of any of claim 25, wherein whenever the value of the metric for the selected antenna direction raises above the value of the metric last used to select the antenna direction by an upper hysteresis margin for a second time-to-trigger period, the value of the metric last used to select the antenna direction is set to the value of the metric for the selected antenna direction.

30. The transceiver of any one of claim 25, wherein the antenna direction is not reselected if the antenna is in use for providing a channel subject to a guaranteed bandwidth constraint.

31. The transceiver of any one of claim 25, wherein the metric is a function of an average received signal-to-interference ratio for signals received by the first antenna that were transmitted by a second antenna.

32. A wireless communication system comprising:
the transceiver of any of claims 17-23 and 25-30; and
a base station including a second antenna for transmitting signals to and receiving signals from the transceiver.

33. The wireless communication system of claim 32, wherein the metric is a function of an average received signal-to-interference ratio for signals received by the first antenna that were transmitted by the second antenna.
